(19) United States
(12) Patent Application Publication
(10) Pub. No.: US 2025/0313068 A1
(43) Pub. Date: Oct. 9, 2025

(54) VEHICLE CONTROL DEVICE

(71) Applicant: Toyota Jidosha Kabushiki Kaisha, Toyota-shi (JP)

(72) Inventor: Masami NAGANO, Seto-shi (JP)

(73) Assignee: Toyota Jidosha Kabushiki Kaisha, Toyota-shi (JP)

(21) Appl. No.: 19/077,124

(22) Filed: Mar. 12, 2025

(30) Foreign Application Priority Data
Apr. 3, 2024 (JP) 2024-060033

(51) Int. Cl. B60J 1/00; B60W 50/14

(52) U.S. Cl. CPC B60J 1/002; B60W 50/14; B60W 2050/143

(57) ABSTRACT

A vehicle control device comprising a processor that:
when it is detected, based on information acquired from a fogging sensor, that a poor visibility region, which is a region around the own vehicle where a driver of the own vehicle cannot visually recognize objects, is present, and when a predetermined condition for determining that a contact risk between a target object located in the poor visibility region and the own vehicle is high is satisfied based on information acquired from a surrounding sensor,
executes a window opening process that controls the window opening device so that the window facing the poor visibility region is opened; and
executes a notification process that controls a notification device (30) so that a predetermined alert is issued to the driver.

### BACKGROUND OF THE INVENTION

The present invention relates to a vehicle control device that controls an own vehicle so that the contact risk between the own vehicle and a target object is reduced.

A vehicle control device that controls an own vehicle so that the contact risk between the own vehicle and a target object is reduced has been proposed (for example, see Patent Document 1 below). The vehicle control device of Patent Document 1 (hereinafter referred to as “conventional device”) predicts a time until the own vehicle and a target object located around the own vehicle make contact, based on the distance between the own vehicle and the target object and the relative speed between them. If the predicted time is equal to or less than a threshold value, a predetermined alert is issued to the driver. As a result, the driver can promptly initiate a driving operation to avoid contact between the own vehicle and the target object, thereby reducing the contact risk between them.
[Patent Document 1] Japanese Unexamined Patent Publication No. 2023-101773

### SUMMARY

Meanwhile, when fogging occurs on part or all of the window glass (door glass) of the own vehicle, it becomes difficult for the driver to visually recognize a target object approaching the own vehicle from the side. Even if the target object is detected based on information acquired by an in-vehicle radar (such as a millimeter-wave radar or an ultrasonic sensor) and an alert is issued to reduce the contact risk between the target object and the own vehicle, the driver may be unable to visually recognize the target object, which may cause confusion. The conventional device includes a function that removes fogging from the windshield by blowing air toward it when fogging is detected. However, it is difficult to remove fogging from the door glass using this function. Even if air were blown toward both the windshield and the door glass, it would take a certain amount of time from the start of the air blowing until the fogging on the door glass is removed. Therefore, in highly urgent situations, such as when a target object suddenly moves toward the own vehicle, the target object may have approached the own vehicle considerably by the time the driver becomes able to visually recognize it.

One of the objectives of the present invention is to provide a vehicle control device that includes a function enabling a driver of an own vehicle to visually recognize a target object at an early stage when fogging has occurred on the glass of the own vehicle and the contact risk between the own vehicle and a target object located in a region facing the glass is high.

To solve the above problem, a vehicle control device (1) of the present invention comprises:
a surrounding sensor (21, 22, 23) that acquires information regarding a target object (MO) located around an own vehicle (V0);
a window opening device (40) that lowers a window glass (DGR, DGL) of the own vehicle to open a window (WR, WL);
a fogging sensor (25) that detects fogging occurring on the window glass;
a processor (10) that executes:
when it is detected, based on information acquired from the fogging sensor, that a poor visibility region (INVR, INVL), which is a region around the own vehicle where a driver of the own vehicle has difficulty in visually recognizing objects, is present, and when a predetermined condition (TTC≤TTCwop, TTC≤TTCalc) for determining that a contact risk between a target object located in the poor visibility region and the own vehicle is high is satisfied based on information acquired from the surrounding sensor, executes a window opening process that controls the window opening device so that the window facing the poor visibility region is opened; and
executes a notification process that controls a notification device so that a predetermined alert is issued to the driver.

When fogging occurs on the window glass of the own vehicle, it becomes difficult for the driver to visually recognize a target object outside the window. The vehicle control device according to the present invention opens the window when a poor visibility region, which is difficult for the driver to recognize due to fogging on the window glass, is present and the contact risk between a target object located in the poor visibility region and the own vehicle is high. This allows the driver to visually recognize the target object relatively earlier compared to a conventional device that removes fogging by blowing air toward the window glass.

In a vehicle control device according to one aspect of the present invention, the processor predicts a time (TTC) until the own vehicle contacts the target object in the poor visibility region, starts the notification process when the predicted time becomes equal to or less than a predetermined first threshold (TTCalc), and starts the window opening process when the predicted time becomes equal to or less than a second threshold (TTCwop) obtained by adding a predetermined time (twop) to the first threshold.

This allows the window to start opening before the alert is issued. As a result, the visibility on the window side is improved at the time the alert is issued or within a short period before or after that time.

In another aspect of the vehicle control device of the present invention, the predetermined time is predetermined based on a time required to transition the window from a fully closed state to a fully opened state.

In this case, the processor can obtain the time required to transition the window from a fully closed state to a fully opened state based on the movement speed of the window glass, which is a known physical quantity, when opening the window using the window opening device. This allows the window opening timing to be determined relatively easily.

Additionally, the predetermined time is determined based on the distance between the own vehicle and the target object and the position of the fogging on the window glass. The predetermined time is also determined based on the position of the fogging on the window glass.

In another aspect of the vehicle control device of the present invention, the vehicle control device includes a driver sensor (26) that detects a height position of the eyes of the driver, and the processor is configured to allocate a larger value to the predetermined time as the height of the driver's eyes becomes lower.

This allows the window opening timing to be determined according to the driver's eye height position. Therefore, when fogging occurs on the entire window glass (or at least the upper part), the visibility on the window side is improved at approximately the same timing as when the alert is issued to the driver.

In another aspect of the vehicle control device of the present invention, the processor executes a voice notification process that controls the notification device so that a predetermined voice urging attention to a target object located outside the window to be opened is issued at a time when the window opening process is started or during execution of the window opening process.

This allows a voice alert urging attention to a target object outside the window to be issued early to the driver. As a result, the safety of the own vehicle and its surroundings is further improved.

### BRIEF DESCRIPTION OF THE DRAWINGS

FIG. 1 is a block diagram of a vehicle control device according to an embodiment of the present invention.

FIG. 2 is a front view of a side door.

FIG. 3 is a plan view showing a poor visibility region.

FIG. 4 is a graph showing the timing at which the side window is opened and the timing at which an alert is issued.

FIG. 5 is a flowchart of a program executed by a CPU to implement the door glass opening function.

FIG. 6 is a plan view showing a poor visibility region according to a modified example of the present invention.

### DESCRIPTION OF THE EMBODIMENTS

### Summary

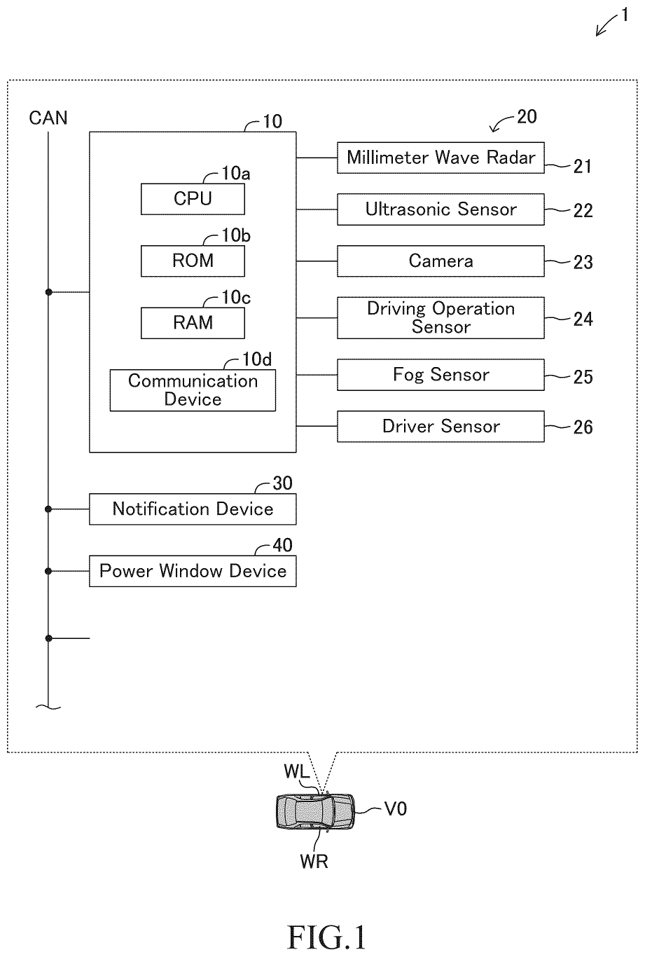

As shown in FIG. 1, a vehicle control device 1 according to an embodiment of the present invention is applied to a vehicle V0 (hereinafter referred to as “own vehicle”) equipped with an autonomous driving function. The vehicle control device 1 includes an alert function that issues a predetermined alert to the driver when the autonomous driving function is disabled (i.e., when the driver is performing driving operations) and the contact risk between the own vehicle and a target object is high. The vehicle control device 1 also has a door glass opening function that opens the door glass of the own vehicle when fogging has occurred on the door glass and the contact risk between a target object located in a predetermined region facing the door glass and the own vehicle is high.

### (Specific Configuration)

As shown in FIG. 1, the vehicle control device 1 includes an ECU 10, in-vehicle sensors 20, a notification device 30, and a power window device 40.

The ECU 10 is a processor installed in the own vehicle and includes a microcomputer comprising a CPU 10a, ROM 10b, RAM 10c, and other components. The ECU 10 is connected to other ECUs via a CAN (Controller Area Network).

The in-vehicle sensors 20 include surrounding sensors that acquire information regarding target objects present around the own vehicle. For example, the in-vehicle sensors 20 include a millimeter-wave radar 21, an ultrasonic sensor 22, and a camera 23 as surrounding sensors.

The millimeter-wave radar 21 includes a transmission/reception unit and a signal processing unit. The transmission/reception unit emits millimeter-wave radio waves (hereinafter referred to as “millimeter waves”) around the own vehicle and receives reflected millimeter waves (reflected waves) that are reflected by three-dimensional objects located in the irradiated region. The signal processing unit acquires various types of information regarding the reflection points of the millimeter waves based on physical quantities related to the transmitted and reflected waves. For example, the signal processing unit calculates the position (relative position, including distance and direction) of each reflection point relative to the own vehicle. The signal processing unit also calculates the speed of each reflection point relative to the own vehicle (the rate of change of distance between the own vehicle and the reflection point per unit time, i.e., relative speed). The signal processing unit then provides the calculation results (distribution data of the reflection points, including relative position and relative speed) to the ECU 10.

The ultrasonic sensor 22 intermittently emits ultrasonic waves around the own vehicle and receives reflected ultrasonic waves (reflected waves) reflected by three-dimensional objects. The ultrasonic sensor 22 recognizes the distance between the own vehicle and each reflection point of the ultrasonic waves, the relative position (direction) of each reflection point relative to the own vehicle, and other data based on the time from transmission to reception of the reflected wave, and transmits the recognition results to the ECU 10.

The camera 23 includes an imaging device and an image analysis device. The imaging device incorporates an imaging element such as a CCD (charge-coupled device) or CIS (CMOS image sensor). The imaging device is installed at the front, rear, left side, and right side of the own vehicle. The imaging device captures images of the surrounding region of the own vehicle at a predetermined frame rate and acquires image data. The imaging device provides each image data to the image analysis device. The image analysis device analyzes the acquired image data to obtain information regarding target objects present around the own vehicle. For example, the image analysis device recognizes moving objects (such as other vehicles and pedestrians) located on the sides of the own vehicle and transmits the recognition results to the ECU 10.

Further, the in-vehicle sensors 20 include a driving operation sensor 24. The driving operation sensor 24 includes a steering wheel sensor that detects the rotational angle position of the steering wheel. Additionally, the driving operation sensor 24 includes an accelerator pedal sensor and a brake pedal sensor, which detect the depression depth of the accelerator pedal and brake pedal, respectively. These sensors provide various detection results to the ECU 10.

The in-vehicle sensors 20 also include a fogging sensor 25. The fogging sensor 25 comprises multiple imaging devices and an image analysis device. These imaging devices are, for example, embedded in the dashboard and directed toward the right and left front door glasses (DGR, DGL). Each imaging device captures images of the door glasses (DGR, DGL) and their surrounding areas at a predetermined frame rate and provides the image data to the image analysis device. The image analysis device analyzes the image data acquired from each imaging device to determine the degree of fogging (condensation, dust adhesion, etc.) on the door glasses (fogging degrees FDR, FDL) and the areas where fogging has occurred on the door glasses (fogging regions FAR, FAL), thereby acquiring (calculating) fogging information FR, FL. For example, the image analysis device calculates the degree of fogging based on the clarity of the scenery outside the door glass. The image analysis device provides the calculation results (fogging information FR, FL) to the ECU 10.

Additionally, the in-vehicle sensors 20 include a driver sensor 26. The driver sensor 26 consists of an imaging device and an image analysis device. The imaging device is, for example, embedded in the instrument panel and directed toward the driver's seat. The imaging device captures images of the driver's face at a predetermined frame rate and provides the obtained image data to the image analysis device. The image analysis device analyzes the image data acquired from the imaging device to detect the position and orientation (gaze direction) of the driver's eyes. The image analysis device then provides the calculation results to the ECU 10.

The notification device 30 includes an image display device and an audio device. The image display device is, for example, installed in the instrument panel (near the speed display device). The image display device displays images according to commands received from the ECU 10. The audio device plays sounds according to commands received from the ECU 10.

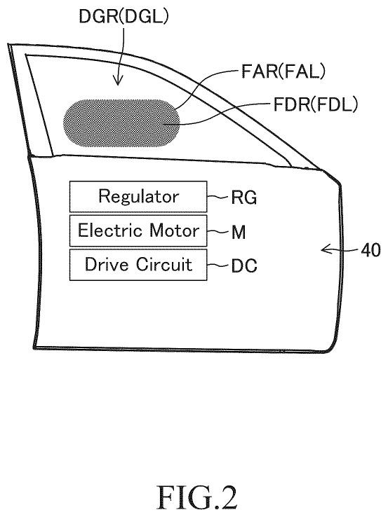

As shown in FIG. 2, the power window device 40 is incorporated into the side doors of the own vehicle. The power window device 40 includes door glasses DGR (DGL), a regulator RG, an electric motor M, and a drive circuit DC. The door glasses DGR (DGL) are guided by grooved components (glass run rails) incorporated into the door frames (window frames) of the side doors, allowing them to slide vertically (open and close the window). The regulator RG is installed inside the door panel (below the door glasses DGR (DGL)) and has a glass support section that supports the lower edge of the door glasses DGR (DGL). Additionally, the regulator RG includes an input shaft (rotary shaft) and a mechanism that converts the rotational movement of the input shaft into the linear movement (up-and-down motion) of the glass support section. The electric motor M (output shaft) is connected to the input shaft of the regulator RG via a reduction gear. The drive circuit DC rotates the electric motor M in the forward or reverse direction in response to commands received from the ECU 10 (commands to open or close the window).

### (Alert Function)

When the ignition switch is in the ON state, the ECU 10 periodically acquires various types of information from the millimeter-wave radar 21, the ultrasonic sensor 22, and the camera 23 and integrates this information to obtain fusion information. The ECU 10 recognizes a moving object MO located on the side of the own vehicle (in the region facing the door glass) based on the fusion information. Furthermore, the ECU 10 acquires the distance Δd between the moving object MO and the own vehicle, as well as the relative speed rv of the moving object MO with respect to the own vehicle, based on the same fusion information. Additionally, the ECU 10 periodically acquires the predicted travel path TR of the own vehicle based on the information obtained from the driving operation sensor 24. The ECU 10 calculates (predicts) the time TTC until contact occurs between the moving object MO and the own vehicle based on the distance Δd, relative speed rv, and predicted travel path TR. When the time TTC is equal to or less than the threshold value TTCalc, the ECU 10 executes the following notification process to reduce the risk of contact between the own vehicle and the moving object MO.

The ECU 10 transmits a predetermined alert command to the notification device 30 to prompt the driver to initiate an avoidance action to avoid contact between the own vehicle and the moving object MO. The image display device of the notification device 30 displays an image corresponding to the alert command, such as an “icon representing a brake pedal” and an “icon representing a steering wheel.” The ECU 10 may also calculate the direction in which the steering wheel should be turned based on the positional relationship between the own vehicle and the moving object MO and display an image (an icon indicating the direction in which the steering wheel should be turned) on the image display device according to the calculation result. Additionally, the audio device of the notification device 30 plays a voice message corresponding to the alert command, such as “Please initiate an avoidance action.”

### (Door Glass Opening Function)

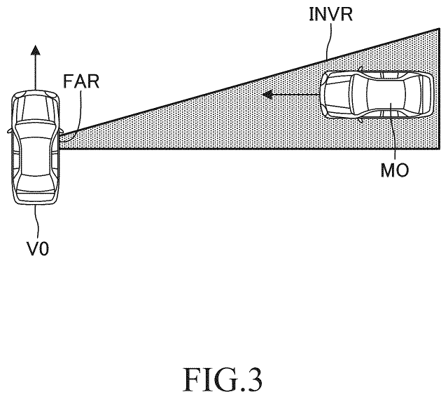

When the ignition switch is in the ON state, the ECU 10 periodically acquires fogging information FR, FL from the fogging sensor 25. The ECU 10 identifies an external area of the door glass DGR (DGL) as a poor visibility region INVR (INVL) if the fogging degree FDR (FDL) exceeds a threshold value FDth. This identification is based on the area between the front and rear edges of the fogging region FAR (FAL) and a predetermined point on the driver's seat (the central part of the driver's face detected by the driver sensor 26) in a plan view (see FIG. 3). If the moving object MO is present within the poor visibility region INVR (INVL), the driver may have difficulty visually recognizing the moving object MO. Therefore, the ECU 10 controls the lowering of the door glass DGR (DGL) to open the right (left) side window WR (WL) when a predetermined condition is met, thereby transitioning the state so that the driver can visually recognize the moving object MO.

For example, when the lower half of the door glass DGR (DGL) constitutes the fogging region FAR (FAL), the driver may have difficulty visually recognizing a target object in a region relatively close to the own vehicle within the poor visibility region INVR (INVL) but may be able to recognize target objects in a region relatively far from the own vehicle. In this case, to improve visibility on the right (left) side of the own vehicle, it is not necessary to fully open the side window WR (WL); rather, lowering the door glass DGR (DGL) to the extent that the upper edge of the fogging region FAR (FAL) retracts into the door panel may be sufficient to improve right (left) side visibility. On the other hand, when the upper half of the door glass DGR (DGL) constitutes the fogging region FAR (FAL), the driver may have difficulty visually recognizing a target object in a region relatively far from the own vehicle within the poor visibility region INVR (INVL) but may be able to recognize target objects in a region relatively close to the own vehicle. In this case, lowering the door glass DGR (DGL) to improve visibility on the right (left) side of the own vehicle results in the fogging region FAR (FAL) lowering in the process. Consequently, the driver may temporarily have difficulty visually recognizing target objects in a region relatively close to the own vehicle, but when the side window WR (WL) is fully opened, right (left) side visibility is improved. Therefore, when fogging occurs on the door glass DGR (DGL), the ECU 10 executes a process to open the side window WR (WL) to an extent that allows the driver to visually recognize the moving object MO within the poor visibility region INVR (INVL). Specifically, the ECU 10 determines a target value for the opening degree of the side window WR (WL) (the lowering amount of the door glass DGR (DGL)) based on the position (upper and lower edges) of the fogging region FAR (FAL) and the distance Δd between the own vehicle and the moving object MO. For example, the ECU 10 refers to a map (database) that defines the relationship between the position (upper and lower edges) of the fogging region FAR (FAL) and the distance Δd, and the target value Δdwt for the lowering amount Δdw of the door glass DGR (DGL), to acquire the target value Δdwt corresponding to the current situation. Then, the ECU 10 obtains a time two (twop=Δdwt/vg) by dividing the lowering amount Δdw by the lowering speed vg of the door glass DGR (DGL). The lowering speed vg is pre-measured and stored in ROM 10b.

For simplicity, the ECU 10 may determine the time twop as the time required from when the door glass DGR (DGL) starts lowering until the upper edge of the fogging region FAR (FAL) reaches the upper edge of the door panel, regardless of the position of the moving object MO. Specifically, the ECU 10 may determine the target value Δdwt as the distance between the upper edge of the fogging region FAR (FAL) and the upper edge of the fogging region FAR (FAL) based on the fogging information FR (FL) acquired from the fogging sensor 25.

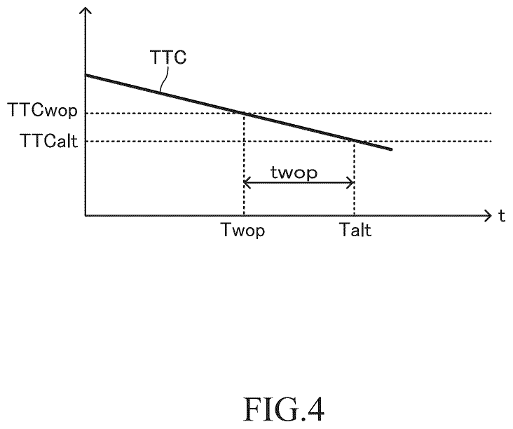

As described above, the ECU 10 sequentially calculates the time TTC until the own vehicle and the moving object MO make contact. When the time TTC reaches the threshold value TTCalc or below at time Talt, the ECU 10 controls the notification device 30 to issue a predetermined alert (see FIG. 4). If fogging has occurred on the door glass DGR (DGL), the ECU 10 initiates the window opening process to lower the door glass DGR (DGL) at a predetermined timing (time Twop), which is before the timing when the alert is issued (time Talt). Specifically, the ECU 10 determines the threshold value TTCwop by adding the time twop to the threshold value TTCalc. When the time TTC decreases to the threshold value TTCwop or below at time Twop, the ECU 10 commands the power window device 40 to start lowering the door glass DGR (DGL). Then, at time Talt, when the time TTC reaches the threshold value TTCalc or below, the ECU 10 commands the power window device 40 to stop lowering the door glass DGR (DGL) and controls the notification device 30 to issue the predetermined alert.

However, if opening the side window WR (WL) is likely to interfere with driving operations, the ECU 10 disables the above-described door glass opening function. For example, if the ECU 10 detects, based on the output of an unillustrated sensor, that the rainfall exceeds a threshold value (heavy rain), it disables the door glass opening function. Similarly, if the ECU 10 detects, based on the output of an unillustrated sensor, that the wind speed exceeds a threshold value (strong wind), it disables the door glass opening function.

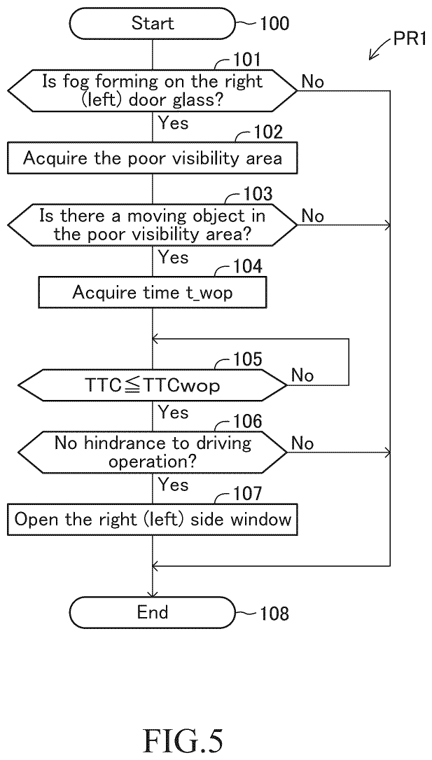

Next, with reference to FIG. 5, the process (program PL1) executed by the CPU 10a of the ECU 10 (hereinafter simply referred to as “CPU”) to implement the above-described door glass opening function will be specifically explained.

The CPU executes program PL1 at a predetermined cycle. The CPU starts executing program PL1 from step 100 and proceeds to step 101.

At step 101, the CPU acquires fogging information FR (FL) from the fogging sensor 25 and determines whether fogging has occurred on the right (left) door glass DGR (DGL) based on the acquired information. If the CPU determines that fogging has occurred on the right (left) door glass DGR (DGL) (101: Yes), it proceeds to step 102. On the other hand, if the CPU determines that fogging has not occurred on the right (left) door glass DGR (DGL) (101: No), it proceeds to step 108 and terminates the execution of program PL1 at step 108.

The CPU acquires (identifies) the poor visibility region INVR (INVL) based on information acquired from the fogging sensor 25 and the driver sensor 26 at step 102. The CPU then proceeds to step 103.

At step 103, the CPU determines whether the moving object MO is present within the poor visibility region INVR (INVL) based on fusion information. If the CPU determines that the moving object MO is present within the poor visibility region INVR (INVL) (103: Yes), it proceeds to step 104. Otherwise (103: No), it proceeds to step 108.

At step 104, the CPU determines (acquires) the time twop based on fusion information and fogging information FR (FL). The CPU then proceeds to step 105.

At step 105, the CPU acquires the time TTC until the own vehicle and the moving object MO make contact based on fusion information and information acquired from the driving operation sensor 24, and determines whether the time TTC is equal to or less than the threshold value TTCwop. If the CPU determines that the time TTC is equal to or less than the threshold value TTCwop (105: Yes), it proceeds to step 106. Otherwise (105: No), it returns to step 105.

At step 106, the CPU determines whether the situation allows for opening the side window WR (WL) without significantly interfering with driving operations. If the CPU determines that opening the side window WR (WL) is unlikely to interfere with driving operations (106: Yes), it proceeds to step 107. Otherwise (106: No), it proceeds to step 108.

At step 107, the CPU controls the power window device 40 so that the side window WR (WL) is opened. The CPU then proceeds to step 108, where it terminates the execution of program PR1.

In parallel with the execution of program PR1, the CPU periodically executes another program PR2 (not shown). Program PR2 includes a step that controls the notification device 30 to issue a predetermined alert when the time TTC is equal to or less than the threshold value TTCalc.

### (Effects)

When fogging occurs on the door glass DGR (DGL) of the own vehicle, the driver has difficulty visually recognizing the moving object MO outside the side window WR (WL). The vehicle control device 1 of this embodiment opens the side window WR (WL) when a poor visibility region INVR (INVL) exists due to fogging on the door glass DGR (DGL), and the contact risk between a moving object MO located in the poor visibility region INVR (INVL) and the own vehicle is high. This allows the driver to visually recognize the moving object MO relatively earlier than conventional devices that remove fogging by blowing air onto the door glass DGR (DGL).

### Modification Example 1

In the above embodiment, the fogging sensor 25 detects the fogging degree FDR (FDL) of the door glass DGR (DGL) based on the clarity of the image outside the door glass DGR (DGL). Instead, the fogging degree FDR (FDL) may be detected (predicted) based on other physical quantities. For example, the lower the sunlight intensity, the less the door glass DGR (DGL) warms up, making it more prone to fogging. Additionally, on rainy days, the higher humidity increases the likelihood of fogging on the door glass DGR (DGL). Furthermore, the lower the outside temperature, the easier it is for the door glass DGR (DGL) to cool, leading to fogging. If the outside temperature is high and the air conditioning system blows cool air onto the door glass DGR (DGL), fogging is also more likely to occur. The higher the vehicle speed, the more the running wind cools the door glass DGR (DGL), making it more prone to fogging. Additionally, the greater the number of occupants, the higher the humidity inside the vehicle due to increased exhalation and perspiration, which can also cause fogging.

To address this, the fogging sensor 25 may include an environmental sensor that acquires information on weather (sunlight intensity), humidity and temperature inside and outside the vehicle, and air conditioning settings (set temperature, air volume, airflow direction, etc.), and estimate the fogging degree FDR (FDL) based on these detection results. Additionally, the fogging sensor 25 may include a vehicle speed sensor to detect the vehicle speed and estimate the fogging degree FDR (FDL) based on the vehicle speed. In this case, the fogging sensor 25 may be configured so that the higher the vehicle speed, the lower the fogging degree FDR (FDL). Furthermore, the fogging sensor 25 may include a sensor that detects the number of occupants and estimate the fogging degree FDR (FDL) based on the number of occupants. In this case, the fogging sensor 25 may be configured so that the greater the number of occupants, the higher the fogging degree FDR (FDL). When estimating the fogging degree FDR (FDL) based on the output of environmental sensors, vehicle speed sensors, and other sensors, it is difficult to estimate the position and size of the fogging region FAR (FAL). Therefore, in this case, it is preferable to assume that fogging has occurred on the entire door glass DGR (DGL) and set the poor visibility region INVR (INVL) and the time twop accordingly. The ECU 10 may then control the power window device 40 so that the door glass DGR (DGL) is fully opened from time Twop when the time TTC becomes equal to or less than the threshold value TTCwop.

### Modification Example 2

For example, when the driver's eyes are at a relatively low position, the driver is more likely to visually recognize the moving object MO when the door glass DGR (DGL) has lowered by a relatively large amount. To address this, the ECU 10 acquires the driver's eye height position from the driver sensor 26. Alternatively, the ECU 10 may estimate the driver's eye height position based on information (seat height) acquired from an unillustrated driver seat sensor (seat height sensor). The ECU 10 then determines the timing for lowering the door glass DGR (DGL) according to the driver's eye height position. Specifically, the lower the driver's eye height position, the greater the value assigned to the time twop.

### Modification Example 3

At the time Twop when the door glass DGR (DGL) starts opening, the ECU 10 may control the notification device 30 to issue a predetermined voice alert (a voice alert prompting attention to the moving object MO on the side of the own vehicle) to the driver.

### Modification Example 4

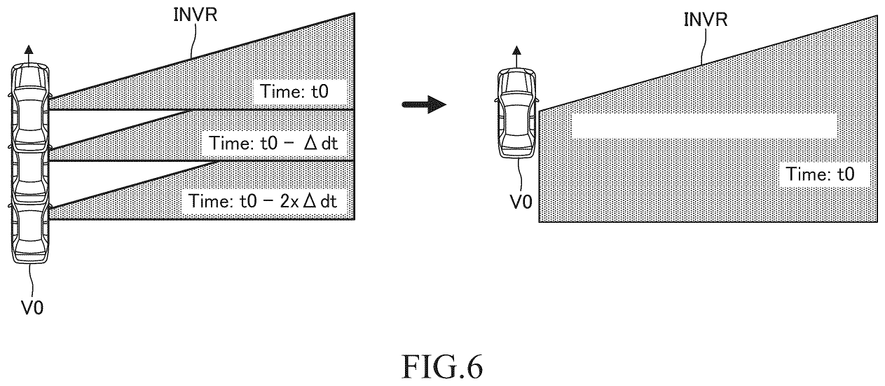

As shown in FIG. 6, the ECU 10 may acquire a poor visibility region INVR (INVL) by determining the logical OR of poor visibility regions detected within a predetermined period T (t0, t0−λdt, t0−2×Δdt) immediately before the current time to and treating the obtained region as the current poor visibility region INVR (INVL).

What is claimed is:

1. A vehicle control device comprising:
a surrounding sensor that acquires information regarding a target object located around an own vehicle;
a window opening device that lowers a window glass of the own vehicle to open a window;
a fogging sensor that detects fogging occurring on the window glass;
a processor that:
when it is detected, based on information acquired from the fogging sensor, that a poor visibility region, which is a region around the own vehicle where a driver of the own vehicle has difficulty in visually recognizing objects, is present, and when a predetermined condition for determining that a contact risk between a target object located in the poor visibility region and the own vehicle is high is satisfied based on information acquired from the surrounding sensor,
executes a window opening process that controls the window opening device so that the window facing the poor visibility region is opened; and
executes a notification process that controls a notification device so that a predetermined alert is issued to the driver.

2. The vehicle control device according to claim 1, wherein
the processor is configured to predict a time until the own vehicle contacts the target object in the poor visibility region, start the notification process when the predicted time becomes equal to or less than a predetermined first threshold, and start the window opening process when the predicted time becomes equal to or less than a second threshold obtained by adding a predetermined time to the first threshold.

3. The vehicle control device according to claim 2, wherein
the predetermined time is predetermined based on a time required to transition the window from a fully closed state to a fully opened state.

4. The vehicle control device according to claim 2, wherein
the vehicle control device includes a driver sensor that detects a height position of the eyes of a driver, and
the processor is configured to allocate a larger value to the predetermined time as the height of the driver's eyes becomes lower.

5. The vehicle control device according to claim 1, wherein
the processor is configured to execute a voice notification process that controls the notification device so that a predetermined voice urging attention to a target object located outside the window to be opened is issued at a time when the window opening process is started or during execution of the window opening process.
